(19) United States
(12) Patent Application Publication
(10) Pub. No.: US 2026/0212177 A1
(43) Pub. Date: Jul. 23, 2026

(54) CONSTELLATION DIAGRAM DETERMINATION METHOD AND APPARATUS, AND DEVICE AND STORAGE MEDIUM

(71) Applicant: ZTE CORPORATION, Shenzhen (CN)

(72) Inventors: Wanjin ZHANG, Shenzhen (CN); Zhen YANG, Shenzhen (CN)

(73) Assignee: ZTE CORPORATION, Shenzhen (CN)

(21) Appl. No.: 19/140,096

(22) PCT Filed: Jan. 25, 2024
(86) PCT No.: PCT/CN2024/073939

§ 371 Date: Jun. 17, 2025

(30) Foreign Application Priority Data
May 8, 2023 (CN) 202310517375.4

(51) Int. Cl. G06N 3/08; H04L 25/02; H04L 27/38

(52) U.S. Cl. CPC G06N 3/08; H04L 25/0254; H04L 27/38

(57) ABSTRACT

Provided are a constellation diagram determination method, a device, and a storage medium. The constellation diagram determination method includes: acquiring channel characteristic information and M modulation bit sequences; and determining a constellation diagram corresponding to the M modulation bit sequences through a pre-trained neural network, where M denotes the number of points in the modulation constellation diagram, and the constellation diagram corresponds to the channel characteristic information.

### TECHNICAL FIELD

The present application relates to the technical field of communications, for example, a constellation diagram determination method and apparatus, a device, and a storage medium.

### BACKGROUND

A digital communication system is a system that utilizes digital signals to transmit information. In the digital communication system, to-be-sent information is transmitted on a carrier. Mapping between the to-be-sent information and information transmitted on the carrier usually uses digital modulation. In digital modulation, signals may be distinguished in amplitude and phase, and each combination of amplitude and phase may be represented as a point in a two-dimensional space. Points of all combinations of amplitude and phase may be regarded as a constellation diagram on a two-dimensional plane, that is, the constellation diagram includes multiple constellation points, and each constellation point is obtained by combining amplitude and phase. Generally, the to-be-sent information is encoded and then mapped to the constellation diagram to achieve digital modulation.

In addition, a neural network has excellent performance in the fields of image and natural language processing. Based on this, the neural network may also be applied to a physical layer of wireless communication, such as encoding and decoding, modulation and demodulation, and channel estimation. Therefore, how to utilize a neural network to design a constellation diagram has become a technical problem that needs to be solved urgently by those skilled in the art.

### SUMMARY

Embodiments of the present application provide a constellation diagram determination method and apparatus, a device, and a storage medium.

In a first aspect, an embodiment of the present application provides a constellation diagram determination method. The method includes acquiring channel characteristic information and M modulation bit sequences and determining a constellation diagram corresponding to the M modulation bit sequences through a pre-trained neural network, where M denotes a number of points in the modulation constellation diagram, and the constellation diagram corresponds to the channel characteristic information.

In a second aspect, an embodiment of the present application provides a constellation diagram determination apparatus. The apparatus includes an acquisition module configured to acquire channel characteristic information and M modulation bit sequences and a determination module configured to determine a constellation diagram corresponding to the M modulation bit sequences through a pre-trained neural network, where M denotes a number of points in the modulation constellation diagram, and the constellation diagram corresponds to the channel characteristic information.

In a third aspect, an embodiment of the present application provides an electronic device including a memory and a processor, where the memory is configured to store a computer program that, when executed by the processor, causes the processor to perform the constellation diagram determination method provided in the first aspect of the embodiment of the present application.

In a fourth aspect, an embodiment of the present application provides a storage medium storing a computer program that, when executed by a processor, causes the processor to perform the constellation diagram determination method provided in the first aspect of the embodiment of the present application.

In the technical solution provided in the embodiment of the present application, the channel characteristic information and the M modulation bit sequences are acquired, and the constellation diagram corresponding to the preceding M modulation bit sequences is determined through the pre-trained neural network, where M denotes the number of points in the modulation constellation diagram, and the preceding constellation diagram corresponds to the channel characteristic information. In the method, the constellation diagram used by both communication parties during communication can be adaptively changed based on different channel characteristics so that the determined constellation diagram can enjoy a high matching degree with the current channel characteristics, thereby improving the performance of the constellation diagram and thus improving the communication performance.

### BRIEF DESCRIPTION OF DRAWINGS

FIG. 1 is a flowchart of a constellation diagram determination method according to an embodiment of the present application.

FIG. 2 is a flowchart of a neural network determination process according to an embodiment of the present application.

FIG. 3 is a structural diagram of a neural network according to an embodiment of the present application.

FIG. 4 is another structural diagram of a neural network according to an embodiment of the present application.

FIG. 5 is another structural diagram of a neural network according to an embodiment of the present application.

FIG. 6 is another structural diagram of a neural network according to an embodiment of the present application.

FIG. 7 is a structural diagram of a neural network in the conventional technology.

FIG. 8 is a graph of mutual information empirical cumulative distribution functions of constellation diagrams according to the conventional technology and an embodiment of the present application.

FIG. 9 is a structural diagram of a constellation diagram determination apparatus according to an embodiment of the present application.

FIG. 10 is a structural diagram of an electronic device according to an embodiment of the present application.

### DETAILED DESCRIPTION

Embodiments described herein are intended to explain the present application. The embodiments of the present application are described hereinafter in detail in conjunction with drawings.

The constellation diagram determination method provided in embodiments of the present application may be applied to various wireless communication systems such as a satellite communications system, the Internet of things (IoT), the Narrowband Internet of things (NB-IoT), the global system for mobile communications (GSM), an enhanced data rates for GSM evolution (EDGE) system, a wideband code-division multiple access (W-CDMA) system, a code-division multiple access 2000 (CDMA2000) system, a time-division synchronous code-division multiple access (TD-SCDMA) system, a long-term evolution (LTE) system, a 4th-generation (4G) system, a 5th-generation (5G) system, an LTE-5G hybrid architecture system, a 5G New Radio (NR) system, and a new communication system emerging in future communication development, such as a 6th-generation (6G) system.

To facilitate a better understanding by those skilled in the art, the relevant concepts involved in the embodiments of the present application are described below.

A constellation diagram is used for not only modulating a signal when a communication node sends the signal, but also demodulating a signal when the communication node receives the signal. Therefore, both the receiving end and the sending end are required to use the same constellation diagram for communications. Generally, the constellation diagram may be used for defining an amplitude and a phase of a signal element. In digital modulation, signals may be distinguished in amplitude and phase. In the constellation diagram, one signal element may be represented by one constellation point, and each combination of amplitude and phase may be represented as one constellation point. For example, in the constellation diagram, the horizontal X-axis is related to an in-phase carrier, and the vertical Y-axis is related to an orthogonal carrier.

The number and coordinates of constellation points in constellation diagrams in different modulation and demodulation manners may be different. For example, the modulation and demodulation manners include quadrature phase-shift keying (QPSK), 16-quadrature amplitude modulation (16-QAM), or 64-QAM. When there are x constellation points in a constellation diagram, it indicates that each constellation point may represent log₂ (x) bits of binary information. For example, there are four constellation points in a QPSK constellation diagram, each constellation point may represent two bits of binary information, and each point may also be regarded as a code with two bits of binary information. Codes corresponding to the four constellation points are 00, 01, 10, and 11 respectively, and coordinates of the four constellation points may be [1, 1], [−1, 1], [1, −1], and [−1, −1] respectively. Considering energy normalization, the horizontal and vertical coordinates of each constellation point may also be divided by \sqrt{2}. During modulation, to-be-sent binary information is encoded and then mapped to the constellation points in the constellation diagram, and digital modulation (that is, constellation modulation) may be achieved. During demodulation, which signal sent by the sending end is determined according to the distance between the received signal and each constellation point in the constellation diagram to correctly demodulate data. For example, when a received QPSK signal is demodulated, according to the distances between the QPSK signal and the four constellation points in the constellation diagram, if the distance to point 00 is the closest, it may be determined that the received QPSK signal is 00; alternatively, if the four constellation points in the QPSK constellation diagram are symmetrically distributed in the four quadrants, a receiver may complete the demodulation of the signal by determining which quadrant the received signal is located in.

A neural network has an input layer and an output layer, and there is at least one hidden layer between the input layer and the output layer. There may be a nonlinear activation function after the at least one hidden layer, such as a rectified linear unit (ReLU) function or a tanh function. The input layer, the output layer, and the at least one hidden layer may be collectively referred to as network layers or simply layers. The layers are connected to each other through nodes on each layer, and a pair of connected nodes has a weight value and a bias value. The neural network may be regarded as a nonlinear transformation from input to output. The loss of the output may also be calculated through a loss function. In this manner, the weight and bias values of each layer are updated to minimize the loss.

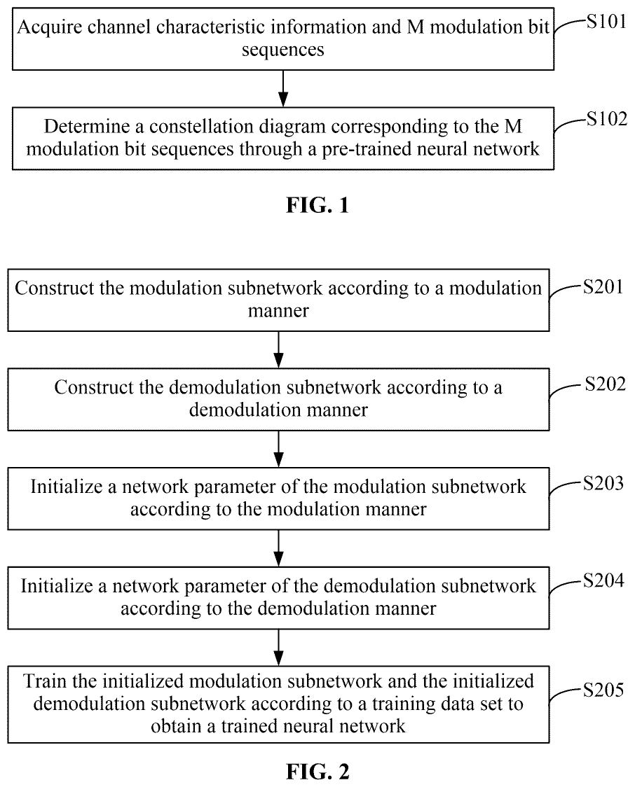

FIG. 1 is a flowchart of a constellation diagram determination method according to an embodiment of the present application. As shown in FIG. 1, the method may include the following:

In S101, channel characteristic information and M modulation bit sequences are acquired.

In S102, a constellation diagram corresponding to the M modulation bit sequences is determined through a pre-trained neural network.

M denotes the number of points in the modulation constellation diagram, and the constellation diagram corresponds to the channel characteristic information.

The channel characteristic information is a description of channel environment in which a communication node is located, and may be a result of statistics over a period of time. The channel characteristic information may include type indications of the channel environment, such as a city, a village, an office, a street, and a home, which may reflect different channel characteristics. The channel characteristic information may include channel model indications. Multiple channel models may be stored in a communication system, and each channel model may correspond to different scenarios. Channel characteristics of the current scenario may be informed by providing a channel model indication. The channel characteristic information may be a channel model obtained by statistics, may be a channel model determined based on methods such as ray tracing, or may be a channel model implemented by the neural network.

The preceding M modulation bit sequences are to-be-modulated binary information. After the channel characteristic information and the M modulation bit sequences are acquired, the channel characteristic information and the M modulation bit sequences are input into the pre-trained neural network, and the constellation diagram corresponding to the M modulation bit sequences may be obtained through the trained neural network. Exemplarily, assuming that Mis 4, the four modulation bit sequences are 00, 01, 10, and 11 respectively, the four modulation bit sequences and the current channel characteristic information are input into the pre-trained neural network to obtain coordinates of four constellation points, and the four constellation points form the corresponding constellation diagram.

In the constellation diagram determination method provided in the embodiment of the present application, the channel characteristic information and the M modulation bit sequences are acquired, and the constellation diagram corresponding to the preceding M modulation bit sequences is determined through the pre-trained neural network, where M denotes the number of points in the modulation constellation diagram, and the preceding constellation diagram corresponds to the channel characteristic information. In the method, the constellation diagram used by both communication parties during communication can be adaptively changed based on different channel characteristics so that the determined constellation diagram can enjoy a high matching degree with the current channel characteristics, thereby improving the performance of the constellation diagram and thus improving the communication performance.

In an embodiment, the preceding neural network may include a modulation subnetwork and a demodulation subnetwork. In this embodiment, both modulation and demodulation are implemented using the neural network. A constellation diagram is designed for any channel by performing end-to-end learning on the modulation subnetwork and the demodulation subnetwork. As shown in FIG. 2, the preceding neural network may be determined in the following manner.

In S201, the modulation subnetwork is constructed according to a modulation manner.

Constructing the modulation subnetwork according to the modulation manner refers to constructing the modulation subnetwork according to a calculation formula of the modulation manner. It is to convert an operation in the calculation formula of the modulation manner into a combination of network layers. For example, a linear operation y=a₁x₂+a₂x₂+b₁ may be converted into a fully-connected layer, and the relationship between the output y of the fully-connected layer and the input [x₁; x₂] of the fully-connected layer is that y=W [x₁; x₂]+b.

A modulation manner may be a quadrature amplitude modulation (QAM) manner, an amplitude and phase-shift keying (APSK) modulation manner, or another modulation manner. This embodiment does not limit the modulation manner.

In S202, the demodulation subnetwork is constructed according to a demodulation manner.

Constructing the demodulation subnetwork according to the demodulation manner refers to constructing the demodulation subnetwork according to a calculation formula of the demodulation manner. It is to convert an operation in the calculation formula of the demodulation manner into a combination of network layers. For example, a linear operation y=a₁x₂+a₂x₂+b₁ may be converted into a fully-connected layer, and the relationship between the output y of the fully-connected layer and the input [x₁; x₂] of the fully-connected layer is that y=W [x₁; x₂]+b.

A demodulation manner may be a boundary method demodulation manner, a formula method demodulation manner, or another demodulation manner. This embodiment does not limit the demodulation manner. In S203, a network parameter of the modulation subnetwork is initialized according to the modulation manner.

Initializing the network parameter of the modulation subnetwork according to the modulation manner refers to determining a first initial parameter of the modulation subnetwork according to a calculation formula of the modulation manner and initializing parameters of network layers of the modulation subnetwork according to the first initial parameter. It is to convert the operation in the calculation formula into the combination of the network layers and then determine the parameters of the network layers according to the operation. For example, after the linear operation is converted into the fully-connected layer, a weight coefficient W of the fully-connected layer may be determined as [a₁, a₂] and a bias coefficient b of the fully-connected layer may be determined as b₁ according to a coefficient of the linear operation.

Initializing the modulation subnetwork may include initialization without scrambling and scrambling initialization. When the initialization without scrambling is adopted, the modulation subnetwork is initialized directly according to the first initial parameter. When the scrambling initialization is adopted, the process of initializing the modulation subnetwork according to the first initial parameter may include scrambling the first initial parameter and initializing the modulation subnetwork according to the scrambled first initial parameter.

The scrambling process may be to add random noise to the first initial parameter so that the initial state of the modulation subnetwork deviates from the modulation manner; in this manner, more network parameters in the modulation subnetwork are changeable, and the expression ability of the modulation subnetwork is increased. For example, when the network parameters [c₁, c₂, c₃, . . . , cₙ] enable the modulation subnetwork to implement the modulation manner, the scrambling initialization is to initialize the modulation subnetwork with [c₁+w₁, c₂+w₂, c₃+w₃, . . . , cₙ+wₙ], where [w₁, w₂, w₃, . . . , wₙ] is the random noise.

In S204, a network parameter of the demodulation subnetwork is initialized according to the demodulation manner.

Initializing the network parameter of the demodulation subnetwork according to the demodulation manner refers to determining a second initial parameter of the demodulation subnetwork according to a calculation formula of the demodulation manner and initializing parameters of network layers of the demodulation subnetwork according to the second initial parameter. It is to convert the operation in the calculation formula into the combination of the network layers and then determine the parameters of the network layers according to the operation. For example, after the linear operation is converted into the fully-connected layer, a weight coefficient W of the fully-connected layer may be determined as [a₁, a₂] and a bias coefficient b of the fully-connected layer may be determined as b₁ according to a coefficient of the linear operation.

Initializing the demodulation subnetwork may also include initialization without scrambling and scrambling initialization. When the initialization without scrambling is adopted, the demodulation subnetwork is initialized directly according to the second initial parameter. When the scrambling initialization is adopted, the process of initializing the demodulation subnetwork according to the second initial parameter may include scrambling the second initial parameter and initializing the demodulation subnetwork according to the scrambled second initial parameter.

The scrambling process may be to add random noise to the second initial parameter so that the initial state of the demodulation subnetwork deviates from the demodulation manner; in this manner, more network parameters in the demodulation subnetwork are changeable, and the expression ability of the demodulation subnetwork is increased. For example, when the network parameters [c₁₁, c₂₂, c₃₃, . . . , cₙₙ] enable the demodulation subnetwork to implement the demodulation manner, the scrambling initialization is to initialize the demodulation subnetwork with [c₁₁+w₁₁, c₂₂+w₂₂, c₃₃+w₃₃, . . . , cₙₙ+wₙₙ], where [w₁₁, w₂₂, w₃₃, . . . , wₙₙ] is the random noise. In S205, the initialized modulation subnetwork and the initialized demodulation subnetwork are trained according to a training data set to obtain a trained neural network.

The training data set includes multiple pieces of sample channel characteristic information and demodulation bit probabilities corresponding to the M modulation bit sequences under the multiple pieces of sample channel characteristic information.

The multiple pieces of sample channel characteristic information and the M modulation bit sequences are used as the input of the neural network (that is, the modulation subnetwork and the demodulation subnetwork). The demodulation bit probabilities corresponding to the M modulation bit sequences under the multiple pieces of sample channel characteristic information are used as the expected output of the neural network. The neural network is end-to-end trained using a preset loss function until a preset convergence condition is reached, thereby obtaining the trained neural network.

In an embodiment, the modulation subnetwork constructed according to the modulation manner may include a bit selection unit, a coordinate calculation unit, a sign calculation unit, and a normalization unit; and the demodulation subnetwork constructed according to the demodulation manner may include a log-likelihood ratio (LLR) calculation unit and a bit probability calculation unit.

The bit selection unit is configured to select a first bit and a second bit from a modulation bit sequence. The bit selection unit is composed of a fully-connected layer. The input of the bit selection unit is the modulation bit sequence, and the output of the bit selection unit may be the first bit and the second bit among the modulation bit sequence. The relationship formula between the output y of the fully-connected layer and the input x of the fully-connected layer may be expressed as y=Wx+b, where W denotes a weight coefficient of the fully-connected layer, and b denotes a bias coefficient of the fully-connected layer. W and b are collectively referred to as parameters of the fully-connected layer.

The coordinate calculation unit is configured to determine absolute values of coordinates of a constellation point corresponding to the modulation bit sequence through the first bit. The coordinate calculation unit is composed of several fully-connected layers and several nonlinear layers. The relationship formula between the output y of a nonlinear layer and the input x of the nonlinear layer may be expressed as y=f(x), where f represents a nonlinear function. Commonly used nonlinear functions include the ReLU function, the sigmoid function, and others.

The sign calculation unit is configured to determine, through the second bit, a quadrant in which the constellation point corresponding to the modulation bit sequence is located. The sign calculation unit is composed of several fully-connected layers and several nonlinear layers and is configured to determine signs of the coordinates of the constellation point corresponding to the modulation bit sequence through the second bit; thus, the quadrant in which the constellation point is located is determined based on the signs of the coordinates. When the signs of coordinates are all positive, the corresponding constellation point is located in the first quadrant, when the signs of the coordinates are negative and positive respectively, the corresponding constellation point is located in the second quadrant, when the signs of the coordinates are all negative, the corresponding constellation point is located in the third quadrant, and when the signs of the coordinates are positive and negative respectively, the corresponding constellation point is located in a fourth quadrant.

N bit selection units are provided, and N is equal to log₂(M)/2. Q coordinate calculation units are provided, and Q is equal to log₂(M)/2−1.

The normalization unit is configured to normalize the coordinates of the constellation point corresponding to the modulation bit sequence. The normalization unit may be composed of a batch normalization layer and is configured to normalize the coordinates of the constellation point corresponding to the modulation bit sequence to obtain transmission coordinates. The relationship formula between the output y of the batch normalization layer and the input x of the batch normalization layer may be expressed as y=(x−μ)/σ, where μ denotes the average value of x, and σ denotes the standard deviation of x.

Received coordinates are generated by the transmission coordinates through a channel. The channel may be an additive white Gaussian noise channel, a fading noise channel, or another channel.

The received coordinates (that is, a received signal) are received by the demodulation subnetwork that performs demodulation on the received signal. The LLR calculation unit in the demodulation subnetwork is configured to determine an LLR of the received signal. The LLR calculation unit is composed of several fully-connected layers and several nonlinear layers.

The bit probability calculation unit is configured to determine a demodulation bit probability through the LLR of the received signal. The bit probability calculation unit is composed of a nonlinear layer, and the nonlinear layer is a sigmoid function layer. The relationship formula between the output y of the sigmoid function layer and the input x of the sigmoid function layer may be expressed as y=[exp(x)−exp(−x)]/[exp(x)+exp(−x)].

P LLR calculation units are provided, and P is equal to log₂(M)/2.

When the modulation subnetwork is initialized, the method may further include controlling training attributes of the bit selection unit and the sign calculation unit to be untrainable or controlling training attributes of the bit selection unit and the sign calculation unit to be trainable.

The preceding bit selection unit and the preceding sign calculation unit each have a training attribute that is trainable or untrainable. “Trainable” refers to that parameters of the fully-connected layers in the bit selection unit and the sign calculation unit change with the training of the network, and “untrainable” refers to that the parameters of the fully-connected layers in the bit selection unit and the sign calculation unit do not change with the training of the network.

In an embodiment, the preceding modulation subnetwork may further include a coordinate transformation unit, and the coordinate transformation unit is composed of a coordinate transformation layer and is configured to transform the coordinates of the constellation point corresponding to the modulation bit sequence from a first coordinate system to a second coordinate system. The input of the coordinate transformation layer is first coordinates (x₁, x₂) in the first coordinate system, and the output of the coordinate transformation layer is second coordinates (y₁, y₂) of the first coordinates in the second coordinate system. For example, the relationship expression between (x₁, x₂) and (y₁, y₂) may be that y₁=x₂ cos (kx₁), and y₂=x₂ sin (kx₁), where k is a constant coefficient. The preceding formula implements the transformation from a polar coordinate system to a rectangular coordinate system, that is, a square constellation diagram may be transformed into a circular constellation diagram.

The preceding modulation subnetwork may further include a first identity unit composed of several fully-connected layers and several nonlinear layers. The output of the first identity unit is equal to the input of the first identity unit, and the first identity unit is configured to increase the network parameter amount of the modulation subnetwork, thereby increasing the expression ability of the modulation subnetwork.

In an embodiment, the preceding demodulation subnetwork may further include a coordinate inverse transformation unit configured to transform the coordinates of the received signal from the second coordinate system to the first coordinate system. The coordinate inverse transformation unit is composed of a coordinate inverse transformation layer, the input of the coordinate inverse transformation layer is the second coordinates (y₁, y₂) in the second coordinate system, and the output of the coordinate inverse transformation layer is the first coordinates (x₁, x₂) of the second coordinates (y₁, y₂) in the first coordinate system. For example, the relationship expression between (y₁, y₂) and (x₁, x₂) is that x₁=arctan (y₂/y₁)/k, and x₂=sqrt(y₁\hat{ }2+y₂\hat{ }2), where k is a constant coefficient. The preceding formula implements the transformation from the rectangular coordinate system to the polar coordinate system, that is, a circular constellation diagram may be transformed into a square constellation diagram. The coordinate transformation unit in the modulation subnetwork and the coordinate inverse transformation unit in the demodulation subnetwork appear in pairs.

The preceding demodulation subnetwork may further include a second identity unit composed of several fully-connected layers and several nonlinear layers. The output of the second identity unit is equal to the input of the second identity unit, and the second identity unit is configured to increase the network parameter amount of the demodulation subnetwork, thereby increasing the expression ability of the demodulation subnetwork.

In this embodiment, compared with a random initialization manner, by initializing the neural network to the specific modulation manner and the specific demodulation manner, the accuracy of initial network parameters of the neural network is improved, and the network parameter amount of the neural network is reduced, thereby ensuring the stability of a training result and further improving the performance of the constellation diagram.

Subsequently, a neural network initialized based on a modulation manner and a demodulation manner is introduced by using M equal to 64 as an example.

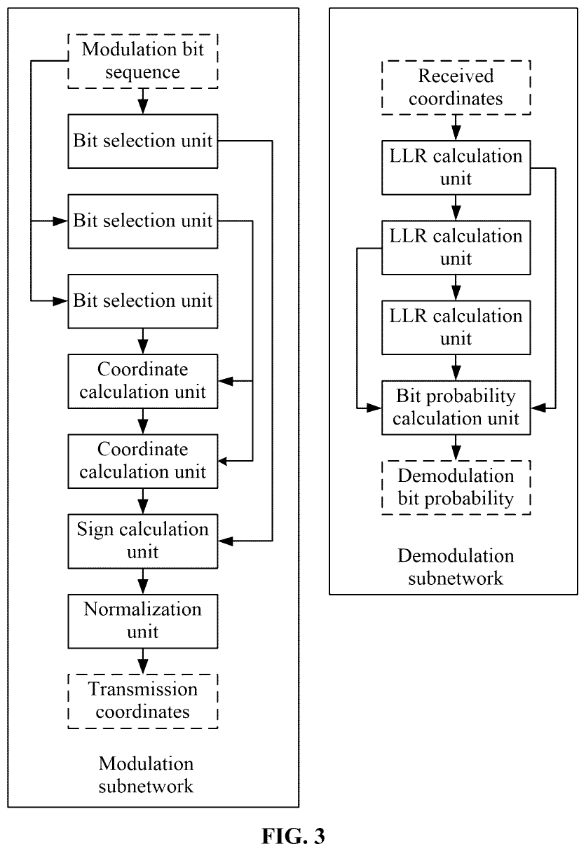

In a first case, a possible structure of the preceding neural network is shown in FIG. 3. The modulation subnetwork in the neural network may include bit selection units, coordinate calculation units, a sign calculation unit, and a normalization unit; and the demodulation subnetwork in the neural network may include LLR calculation units and a bit probability calculation unit, where the number of the bit selection units is equal to 3, the number of the coordinate calculation units is equal to 2, and the number of the LLR calculation units is equal to 3.

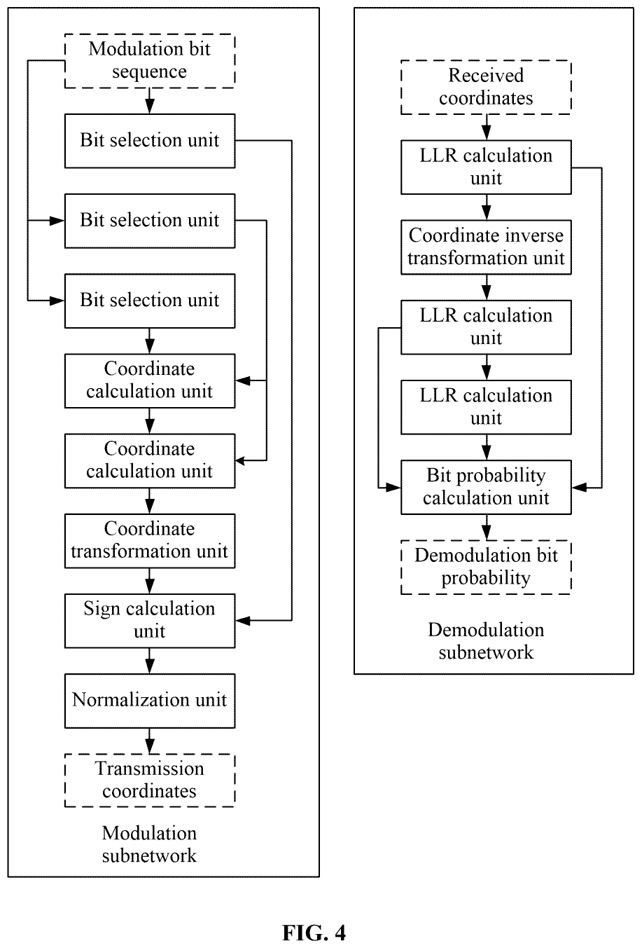

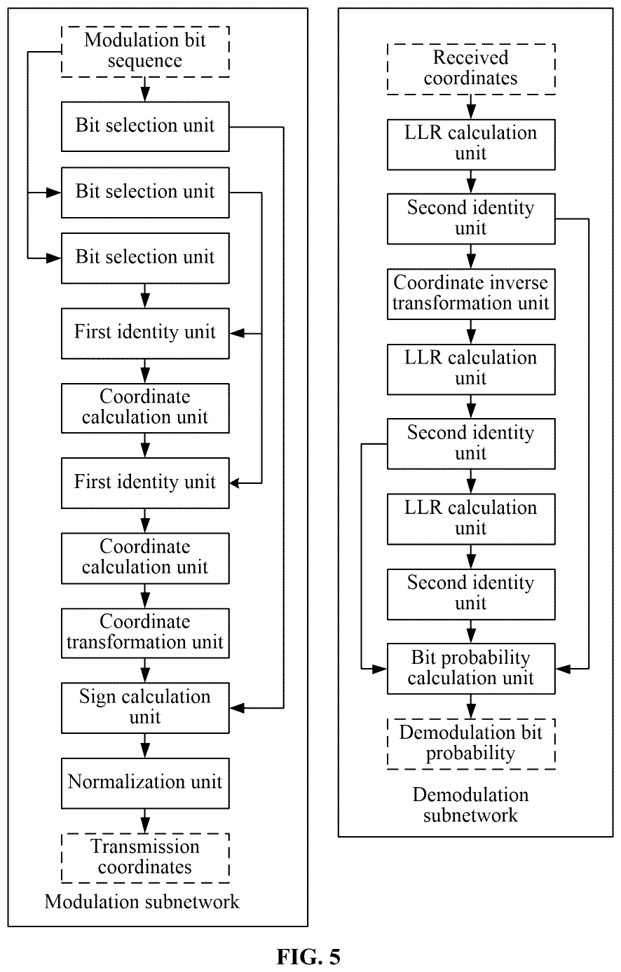

In a second case, a possible structure of the preceding neural network is shown in FIG. 4. The modulation subnetwork in the neural network may include bit selection units, coordinate calculation units, a coordinate transformation unit, a sign calculation unit, and a normalization unit; and the demodulation subnetwork in the neural network may include LLR calculation units, a coordinate inverse transformation unit, and a bit probability calculation unit. That is, the coordinate transformation unit is added to the modulation subnetwork and the coordinate inverse transformation unit is added to the demodulation subnetwork so that the type of the constellation diagram can be transformed.

In a third case, a possible structure of the preceding neural network is shown in FIG. 5. The modulation subnetwork in the neural network may include bit selection units, coordinate calculation units, first identity units, a coordinate transformation unit, a sign calculation unit, and a normalization unit; and the demodulation subnetwork in the neural network may include LLR calculation units, second identity units, a coordinate inverse transformation unit, and a bit probability calculation unit. That is, the coordinate transformation unit and the first identity units are added to the modulation subnetwork, and the coordinate inverse transformation unit and the second identity units are added to the demodulation subnetwork; in this manner, the type of the constellation diagram can be transformed, and the expression ability of the modulation subnetwork and the expression ability of the demodulation subnetwork can be increased.

In a fourth case, initialization without scrambling may be performed on the neural network shown in FIG. 3, FIG. 4, or FIG. 5 so that the neural network starts training from the modulation manner and the demodulation manner.

In a fifth case, scrambling initialization may be performed on the neural network shown in FIG. 3, FIG. 4, or FIG. 5 so that the initial state of the neural network deviates from the modulation manner and the demodulation manner; in this manner, more network parameters in the neural network are changeable, the expression ability of the neural network is increased, thereby improving the performance of the constellation diagram.

In a sixth case, training attributes of the bit selection units and the sign calculation unit in the neural network shown in FIG. 3, FIG. 4, or FIG. 5 may be controlled to be untrainable so that the constellation diagram obtained by training has a certain symmetry, thereby reducing the optimization space of network parameters.

In a seventh case, training attributes of the bit selection units and the sign calculation unit in the neural network shown in FIG. 3, FIG. 4, or FIG. 5 may be controlled to be trainable, thereby increasing the degree of freedom of network parameters in the neural network.

The preceding determination process of the neural network is introduced continuously using M equal to 64 as an example. The neural network is designed according to the structure shown in FIG. 5 (that is, the modulation subnetwork includes the bit selection units, the coordinate calculation units, the first identity units, the coordinate transformation unit, the sign calculation unit, and the normalization unit; and the demodulation subnetwork includes the LLR calculation units, the second identity units, the coordinate inverse transformation unit, and the bit probability calculation unit). The neural network is initialized according to the preceding fourth case and the preceding seventh case. Moreover, the modulation subnetwork is constructed and initialized according to the 64-QAM modulation manner, and the demodulation subnetwork is constructed and initialized according to the 64-QAM boundary method demodulation manner.

For the 64-QAM modulation, when an input modulation bit sequence is b₁b₂b₃b₄b₅b₆, the following formula (1) may be obtained according to the 64-QAM mapping relationship between the modulation bit sequence and the constellation point:

$$[ \begin{matrix}x \\ y\end{matrix} ] = [ \begin{matrix}( 1 - 2 {b}_{1} ) \cdot ( 4 {b}_{3} + 2 \vert {b}_{3} + \text{?} - 1 \vert + 1 ) \\ ( 1 - 2 {b}_{2} ) \cdot ( 4 \text{?} + 2 \vert \text{?} - 1 \vert + 1 )\end{matrix} ] / \sqrt{42} \qquad ( 1 )$$

$$\text{?} \text{indicates text missing or illegible when filed}$$

[x, y] are coordinates of the constellation point. It can be seen from the preceding formula that two bits of b₁b₂ determine the signs of the coordinates of the constellation point, four bits of b₃b₄b₅b₆ determine the absolute values of the coordinates of the constellation point, and the target coordinates of the constellation point may be obtained by multiplying the signs with the absolute values. First, b₁b₂, b₃b₄, and b₅b₆ are selected from the input modulation bit sequence through three coordinate selection units in sequence. The three coordinate selection units are each composed of a fully-connected layer. Weight coefficients of the fully-connected layers are [1, 0, 0, 0, 0, 0; 0, 1, 0, 0, 0, 0], [0, 0, 1, 0, 0, 0; 0, 0, 0, 1, 0, 0], and [0, 0, 0, 0, 1, 0; 0, 0, 0, 0, 0, 1] respectively, and bias coefficients of the fully-connected layers are [0; 0], [0; 0], and [0; 0] respectively.

The calculation of the absolute values of the coordinates may be divided into two steps. The first step is to calculate |b₃+b₅−1| and |b₄+b₆−1| through the four bits of b₃b₄b₅b₆. The second step is to calculate the absolute values of the coordinates through b₃b₄, |b₃+b₅−1|, and |b₄+b₆−1|. The preceding two steps are implemented by two coordinate calculation units respectively. For the first coordinate calculation unit, the calculation of the absolute values is decomposed into the form of a sum of ReLU functions (for example, |x|=ReLU(x)+ReLU(−x)), so |b₃+b₅−1|=ReLU(b₃+b₅−1)+ReLU(−(b₃+b₅−1)). First, b₃+b₅−1, −(b₃+b₅−1), b₄+b₆−1, and −(b₄+b₆−1) are calculated through the fully-connected layer. The weight coefficient of the fully-connected layer and the bias coefficient of the fully-connected layer are [1, 0, 1, 0; −1, 0, −1, 0; 0, 1, 0, 1; 0, −1, 0, −1] and [−1; 1; −1; 1] respectively; then ReLU(b₃+b₅−1), ReLU(−(b₃+b₅−1)), ReLU(b₄+b₆−1), and ReLU(−(b₄+b₆−1)) are obtained through a ReLU function layer; finally, the absolute values of the coordinates may be calculated through a fully-connected layer. The weight coefficient of the fully-connected layer and the bias coefficient of the fully-connected layer are [1, 1, 0, 0; 0, 0, 1, 1] and [0; 0] respectively. The second coordinate calculation unit may be directly implemented through a fully-connected layer. The weight coefficient of the fully-connected layer and the bias coefficient of the fully-connected layer are [4, 0, 2, 0; 0, 4, 0, 2] and [1; 1] respectively.

The first identity unit may be obtained from x=ReLU(x)−ReLU(−x), and the first identity unit may also be implemented by a ReLU function layer and fully-connected layers. When x is a column vector of 4×1, x and −x are first obtained through a fully-connected layer, and the weight coefficient of the fully-connected layer and the bias coefficient of the fully-connected layer are [1, 0, 0, 0; −1, 0, 0, 0; 0, 1, 0, 0; 0, −1, 0, 0; 0, 0, 1, 0; 0, 0, −1, 0; 0, 0, 0, 1; 0, 0, 0, −1] and [0; 0; 0; 0; 0; 0; 0; 0] respectively; then ReLU(x) and ReLU(−x) are obtained through the ReLU function layer; finally, the sum of ReLU(x) and ReLU(−x) is implemented through a fully-connected layer, and the weight coefficient of the fully-connected layer and the bias coefficient of the fully-connected layer are [1, −1, 0, 0, 0, 0, 0, 0; 0, 0, 1, −1, 0, 0, 0, 0; 0, 0, 0, 0, 1, −1, 0, 0; 0, 0, 0, 0, 0, 0, 1, −1] and [0; 0; 0; 0] respectively.

It can be obtained from calculation that the coordinates input to the coordinate transformation unit differ from a constellation point modulated by the 64-QAM by only a multiple, which is 1/sqrt(21). For example, when b₃b₄b₅b₆ is 0000, the coordinates input to the coordinate transformation unit are (3, 3), while the constellation point modulated by the 64-QAM is (3/sqrt(21), 3/sqrt(21)). The signs of the coordinates are all positive, so the constellation point is in the first quadrant. The relationship formula between the input of a coordinate transformation layer of the coordinate transformation unit and the output of the coordinate transformation layer of the coordinate transformation unit is expressed as y₁=x₂ cos (kx₁), and y₂=x₂ sin (kx₁), where k=π/16. The coordinate transformation layer transforms the square coordinates distributed in the first quadrant into ¼ circular coordinates distributed in the first quadrant, and sqrt denotes a square root operation.

The sign calculation unit may be implemented through a fully-connected layer, and the weight coefficient of the fully-connected layer and the bias coefficient of the fully-connected layer are [−2, 0; 0, −2] and [1; 1] respectively. The sign calculation unit maps the ¼ circular coordinates distributed in the first quadrant to the other three quadrants according to signs of the coordinates determined by b₁b₂. In this case, the square constellation diagram distribution modulated by the 64-QAM is transformed into the circular distribution, and since the square constellation diagram distribution is uniformly distributed, the circular constellation diagram distribution is uniformly distributed in angular and radial directions accordingly.

For the 64-QAM boundary method demodulation, when the received signal is (x, y), the following formula (2) is shown based on the boundary method demodulation solution as follows:

$$LLR ( {b}_{1} ) = - x \\ LLR ( {b}_{2} ) = - y \\ LLR ( {b}_{3} ) = \vert LLR ( {b}_{1} ) \vert - 4 / \sqrt{42} \\ LLR ( {b}_{4} ) = \vert LLR ( {b}_{2} ) \vert - 4 / \sqrt{42} \\ LLR ( {b}_{5} ) = \vert LLR ( {b}_{3} ) \vert - 2 / \sqrt{42} \\ LLR ( {b}_{6} ) = \vert LLR ( {b}_{4} ) \vert - 2 / \sqrt{42} \qquad ( 2 )$$

The LLR calculation of b₁b₂ may be implemented through a fully-connected layer, and the weight coefficient of the fully-connected layer and the bias coefficient of the fully-connected layer are [−1, 0; 0, −1] and [0; 0] respectively.

The relationship formula between the input of a coordinate inverse transformation layer of the coordinate inverse transformation unit and the output of the coordinate inverse transformation layer of the coordinate inverse transformation unit is expressed as x₁=arctan(y₂/y₁)/k, and x₂=sqrt(y₁\hat{ }2+y₂\hat{ }2), where k=π/16.

The LLR calculation of b₃b₄ may be implemented using fully-connected layers and a ReLU function layer. Similar to the processing of the absolute values of the coordinates in the modulation part, LLR(b₁), −LLR(b₁), LLR(b₂), and −LLR(b₂) are first calculated through a fully-connected layer, and the weight coefficient of the fully-connected layer and the bias coefficient of the fully-connected layer are [1, 0; −1, 0; 0, 1; 0, −1] and [0; 0; 0; 0] respectively; then ReLU(LLR(b₁)), ReLU(−LLR(b₁)), ReLU(LLR(b₂)), and ReLU(−LLR(b₂)) are obtained through the ReLU function layer; finally, the LLR calculation may be obtained through a fully-connected layer, and the weight coefficient of the fully-connected layer and the bias coefficient of the fully-connected layer are [1, −1, 0, 0; 0, 0, 1, −1] and [−4/sqrt(42); −4/sqrt(42)] respectively.

The LLR calculation of b₅b₆ may be implemented using fully-connected layers and a ReLU function layer. Similar to the processing of the absolute value of the coordinates in the modulation part, LLR(b₃), −LLR(b₃), LLR(b₄), and −LLR(b₄) are first calculated through a fully-connected layer, and the weight coefficient of the fully-connected layer and the bias coefficient of the fully-connected layer are [1, 0; −1, 0; 0, 1; 0, −1] and [0; 0; 0; 0] respectively; then ReLU(LLR(b₃)), ReLU(−LLR(b₃)), ReLU(LLR(b₄)), and ReLU(−LLR(b₄)) are obtained through the ReLU function layer; finally, the LLR calculation may be obtained through a fully-connected layer, and the weight coefficient of the fully-connected layer and the bias coefficient of the fully-connected layer are [1, −1, 0, 0; 0, 0, 1, −1] and [−2/sqrt(42); −2/sqrt(42)] respectively.

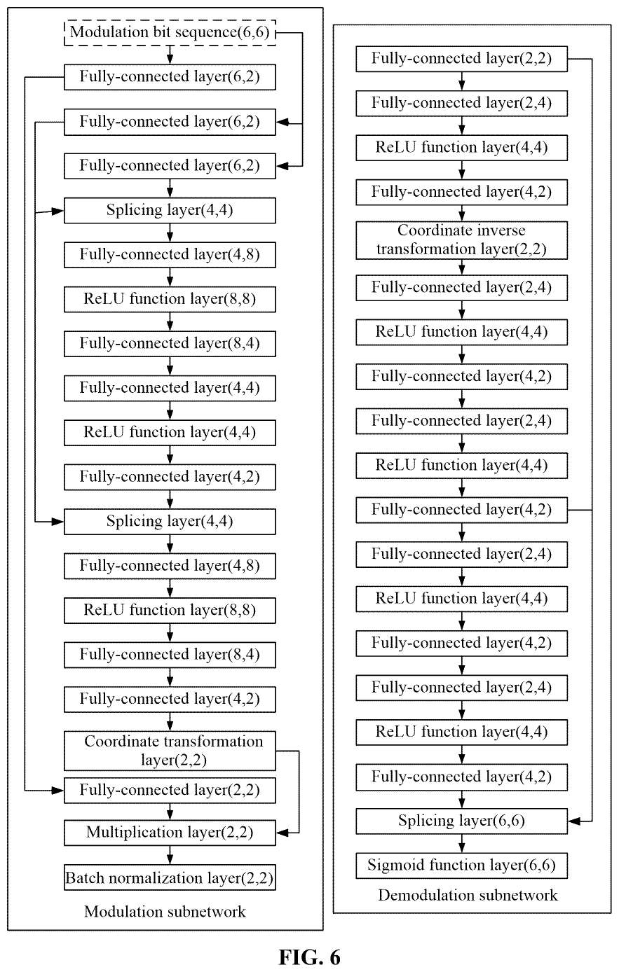

For the second identity unit, it may be obtained from x=ReLU(x)−ReLU(−x), and the second identity unit may also be implemented by a ReLU function layer and fully-connected layers. When x is a column vector of 2×1, x and −x are first obtained through a fully-connected layer, and the weight coefficient of the fully-connected layer and the bias coefficient of the fully-connected layer are [1, 0; −1, 0; 0, 1; 0, −1] and [0; 0; 0; 0] respectively; then ReLU(x) and ReLU(−x) are obtained through the ReLU function layer; finally, the sum of ReLU(x) and ReLU(−x) is implemented through a fully-connected layer, and the weight coefficient of the fully-connected layer and the bias coefficient of the fully-connected layer are [1, −1, 0, 0; 0, 0, 1, −1] and [0; 0] respectively. The structure of the modulation subnetwork and the structure of the demodulation subnetwork that are designed according to the preceding method are shown in FIG. 6. Numbers in brackets represent lengths of input and output vectors respectively, and coefficients of all the fully-connected layers are trainable.

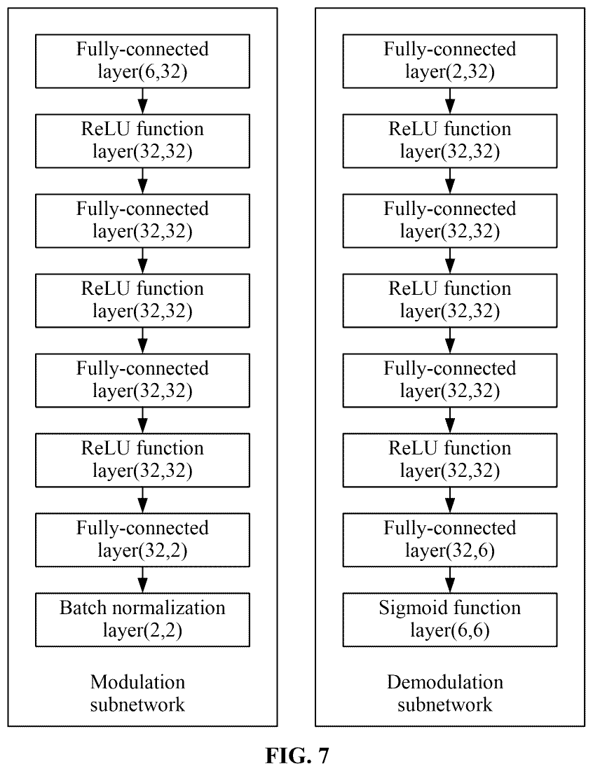

The neural network in the conventional technology is designed as a fully-connected neural network that is implemented through multiple fully-connected layers and a ReLU function layer and is randomly initialized. The structure of the designed modulation subnetwork and the structure of the designed demodulation subnetwork are shown in FIG. 7. Numbers in brackets represent lengths of input and output vectors respectively.

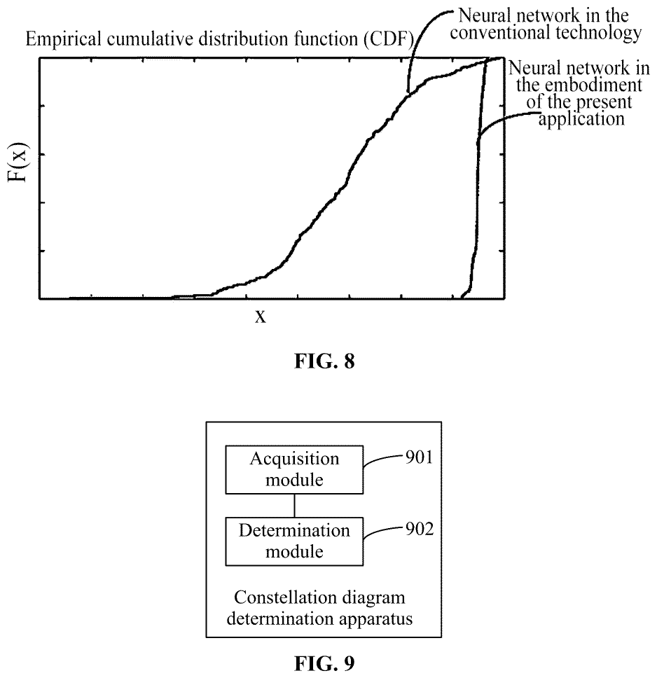

The number of parameters of the two methods and mutual information of the constellation diagram trained multiple times are compared. In terms of the network parameter amount, the parameter amount of the fully-connected neural network in the conventional technology is 4808, while the parameter amount of the neural network constructed and initialized based on the specific modulation manner and the specific demodulation manner in the embodiments of the present application is only 356. A mutual information empirical cumulative distribution function of a constellation diagram obtained after 300 trainings of the neural network in the conventional technology and a mutual information empirical cumulative distribution function of the constellation diagram obtained after 300 trainings of the neural network in the embodiment of the present application are shown in FIG. 8. It can be seen from FIG. 8 that compared with the mutual information distribution of the fully-connected network in the conventional technology, the range of the mutual information distribution of the neural network provided in the embodiments of the present application is narrower and located within a range of 4.78 to 4.8, which means that the constellation diagram obtained and trained through the neural network provided in the embodiment of the present application has a better stability.

FIG. 9 is a structural diagram of a constellation diagram determination apparatus according to an embodiment of the present application. As shown in FIG. 9, the apparatus may include an acquisition module 901 and a determination module 902.

The acquisition module 901 is configured to acquire channel characteristic information and M modulation bit sequences; and the determination module 902 is configured to determine a constellation diagram corresponding to the M modulation bit sequences through a pre-trained neural network, where M denotes the number of points in the modulation constellation diagram, and the constellation diagram corresponds to the channel characteristic information.

In the constellation diagram determination apparatus provided in the embodiment of the present application, the channel characteristic information and the M modulation bit sequences are acquired, and the constellation diagram corresponding to the preceding M modulation bit sequences is determined through the pre-trained neural network, where M denotes the number of points in the modulation constellation diagram, and the constellation diagram corresponds to the channel characteristic information. In the method, the constellation diagram used by both communication parties during communication can be adaptively changed based on different channel characteristics so that the determined constellation diagram can enjoy a high matching degree with the current channel characteristics, thereby improving the performance of the constellation diagram and thus improving the communication performance.

Based on the preceding embodiment, the neural network includes a modulation subnetwork and a demodulation subnetwork; the apparatus may further include a construction module, an initialization module, and a training module. The construction module is configured to construct the modulation subnetwork according to a modulation manner; the construction module is further configured to construct the demodulation subnetwork according to a demodulation manner; the initialization module is configured to initialize a network parameter of the modulation subnetwork according to the modulation manner; the initialization module is further configured to initialize a network parameter of the demodulation subnetwork according to the demodulation manner; the training module is configured to train the initialized modulation subnetwork and the initialized demodulation subnetwork according to a training data set to obtain a trained neural network, where the training data set includes multiple pieces of sample channel characteristic information and demodulation bit probabilities corresponding to the M modulation bit sequences under the multiple pieces of sample channel characteristic information.

Based on the preceding embodiments, the modulation subnetwork includes the following.

A bit selection unit is configured to select a first bit and a second bit from a modulation bit sequence; a coordinate calculation unit is configured to determine absolute values of coordinates of a constellation point corresponding to the modulation bit sequence through the first bit; a sign calculation unit is configured to determine, through the second bit, a quadrant in which the constellation point corresponding to the modulation bit sequence is located; and a normalization unit is configured to normalize the coordinates of the constellation point corresponding to the modulation bit sequence.

Based on the preceding embodiments, N bit selection units are provided, and N is equal to log₂(M)/2; Q coordinate calculation units are provided, and Q is equal to log₂(M)/2−1.

Based on the preceding embodiments, the modulation subnetwork further includes a coordinate transformation unit.

The coordinate transformation unit is configured to transform the coordinates of the constellation point corresponding to the modulation bit sequence from a first coordinate system to a second coordinate system.

Based on the preceding embodiments, the modulation subnetwork further includes a first identity unit.

The first identity unit is configured to increase the network parameter amount of the modulation subnetwork.

Based on the preceding embodiments, the demodulation subnetwork includes the following.

A log-likelihood ratio (LLR) calculation unit is configured to determine an LLR of a received signal, and a bit probability calculation unit is configured to determine a demodulation bit probability through the LLR of the received signal.

Based on the preceding embodiments, P LLR calculation units are provided, and P is equal to log₂(M)/2.

Based on the preceding embodiments, the demodulation subnetwork further includes a coordinate inverse transformation unit.

The coordinate inverse transformation unit is configured to transform coordinates of the received signal from a second coordinate system to a first coordinate system.

Based on the preceding embodiments, the demodulation subnetwork further includes a second identity unit below.

The second identity unit is configured to increase the network parameter amount of the demodulation subnetwork.

Based on the preceding embodiments, the initialization module is configured to determine a first initial parameter of the modulation subnetwork according to a calculation formula of the modulation manner and initialize the modulation subnetwork according to the first initial parameter.

Based on the preceding embodiments, the initialization module is further configured to scramble the first initial parameter and initialize the modulation subnetwork according to the scrambled first initial parameter.

Based on the preceding embodiments, the initialization module is further configured to control training attributes of the bit selection unit and the sign calculation unit to be untrainable or control training attributes of the bit selection unit and the sign calculation unit to be trainable.

Based on the preceding embodiments, the initialization module is further configured to determine a second initial parameter of the demodulation subnetwork according to a calculation formula of the demodulation manner and initialize the demodulation subnetwork according to the second initial parameter.

Based on the preceding embodiments, the initialization module is further configured to scramble the second initial parameter and initialize the demodulation subnetwork according to the scrambled second initial parameter.

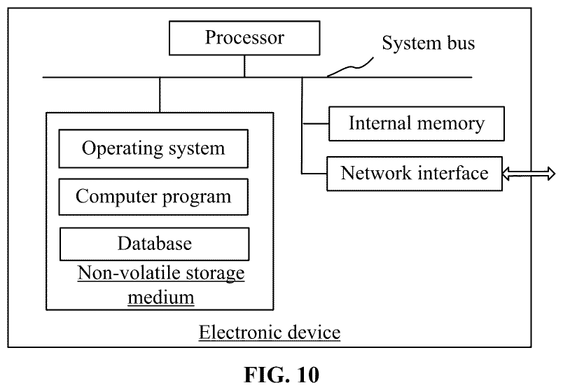

In an embodiment, an electronic device is provided, and the internal structural diagram may be shown in FIG. 10. The electronic device includes a processor, a memory, a network interface, and a database that are connected via a system bus. The processor of the electronic device is configured to provide computing and control capabilities. The memory of the electronic device includes a non-volatile storage medium and an internal memory. The non-volatile storage medium stores an operating system, a computer program, and a database. The internal memory provides an environment for the operation of the operating system and the computer program in the non-volatile storage medium. The database of the electronic device is configured to store data generated during the determination process of a constellation diagram. The network interface of the electronic device is configured to communicate with an external terminal via a network connection. When being executed by the processor, the computer program causes the processor to perform a constellation diagram determination method.

It is to be understood by those skilled in the art that the structure shown in FIG. 10 is a block diagram of some structures related to the solution of the present application and does not limit the electronic device to which the solution of the present application is applied. The electronic device may include more or fewer components than the components shown in the figure, may include a combination of some of the components shown in the figure, or may have a different arrangement of the components shown in the figure.

In an embodiment, an electronic device is provided. The electronic device includes a memory and multiple processors. The memory stores a computer program. When executed by a processor of the multiple processors, the computer program causes the processor to perform the following: acquiring channel characteristic information and M modulation bit sequences and determining a constellation diagram corresponding to the M modulation bit sequences through a pre-trained neural network, where M denotes the number of points in the modulation constellation diagram, and the constellation diagram corresponds to the channel characteristic information.

An embodiment of the present application further provides a computer-readable storage medium storing a computer program that, when executed by a processor, causes the processor to perform the following: acquiring channel characteristic information and M modulation bit sequences and determining a constellation diagram corresponding to the M modulation bit sequences through a pre-trained neural network, where M denotes the number of points in the modulation constellation diagram, and the constellation diagram corresponds to the channel characteristic information.

A computer storage medium of an embodiment of the present application may be one computer-readable medium or any combination of multiple computer-readable media. The computer-readable medium may be a computer-readable signal medium or a computer-readable storage medium. For example, the computer-readable storage medium may be, but is not limited to, an electrical, magnetic, optical, electromagnetic, infrared, or semiconductor system, apparatus, or device or any combination thereof. The computer-readable storage medium includes (a non-exhaustive list) an electrical connection having one or more wires, a portable computer disk, a hard disk, a random access memory (RAM), a read-only memory (ROM), an electrically erasable programmable read-only memory (EPROM), a flash memory, an optical fiber, a portable compact disk read-only memory (CD-ROM), an optical memory, a magnetic memory, or any suitable combination thereof. In the present application, the computer-readable storage medium may be any tangible medium including or storing a program. The program may be used by or used in conjunction with an instruction execution system, apparatus, or device.

The computer-readable signal medium may include a data signal propagated in a baseband or as part of a carrier. The data signal carries computer-readable program codes. The data signal propagated in this manner may be in multiple forms and includes, but is not limited to, an electromagnetic signal, an optical signal, or any suitable combination thereof. The computer-readable signal medium may also be any computer-readable medium other than the computer-readable storage medium. The computer-readable medium may send, propagate, or transmit a program used by or used in conjunction with an instruction execution system, apparatus, or device.

Program codes included on the computer-readable medium may be transmitted by using any appropriate medium including, but not limited to, a radio medium, a wire, an optical cable, radio frequency (RF), and the like, or any appropriate combination thereof.

Computer program codes for executing the operations of the present application may be written in one or more programming languages or a combination of multiple programming languages. The programming languages include object-oriented programming languages (such as Java, Smalltalk, C++, Ruby, and Go) and conventional procedural programming languages (such as “C” or similar programming languages). The program codes may be executed entirely on a user computer, executed partly on a user computer, executed as a stand-alone software package, executed partly on a user computer and partly on a remote computer, or executed entirely on a remote computer or a server. In the case relating to the remote computer, the remote computer may be connected to the user computer via any type of network (including a local area network (LAN) or a wide area network (WAN)) or may be connected to an external computer (for example, via the Internet through an Internet service provider).

It is to be understood by those skilled in the art that the term “user equipment” encompasses any appropriate type of wireless user device, such as a mobile phone, a portable data processing apparatus, a portable web browser, or an in-vehicle mobile station.

Generally speaking, embodiments of the present application may be implemented in hardware or special-purpose circuits, software, logic, or any combination thereof. For example, some aspects may be implemented in hardware while other aspects may be implemented in firmware or software executable by a controller, a microprocessor, or another computing apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, status setting data, or source or object codes written in any combination of one or more programming languages.

A block diagram of any logic flow among the drawings of the present application may represent program operations, may represent interconnected logic circuits, modules, and functions, or may represent a combination of program operations and logic circuits, modules, and functions. Computer programs may be stored in a memory. The memory may be of any type suitable for a local technical environment and may be implemented by using any suitable data storage technology, such as, but not limited to, a read-only memory (ROM), a random-access memory (RAM), and an optical memory apparatus and system (a digital video disc (DVD) or a compact disk (CD)). Computer-readable media may include non-transitory storage media. The data processor may be of any type suitable for the local technical environment, such as, but not limited to, a general-purpose computer, a special-purpose computer, a microprocessor, a digital signal processing (DSP), an application-specific integrated circuit (ASIC), a field-programmable gate array (FPGA), and a processor based on a multi-core processor architecture.

1. A constellation diagram determination method, comprising:
acquiring channel characteristic information and M modulation bit sequences; and
determining a constellation diagram corresponding to the M modulation bit sequences through a pre-trained neural network,
wherein M denotes a number of points in the constellation diagram, and the constellation diagram corresponds to the channel characteristic information.

2. The constellation diagram determination method according to claim 1, wherein the neural network comprises a modulation subnetwork and a demodulation subnetwork; and
the neural network is determined in the following manner:
constructing the modulation subnetwork according to a modulation manner;
constructing the demodulation subnetwork according to a demodulation manner;
initializing a network parameter of the modulation subnetwork according to the modulation manner;
initializing a network parameter of the demodulation subnetwork according to the demodulation manner; and
training the initialized modulation subnetwork and the initialized demodulation subnetwork according to a training data set to obtain a trained neural network,
wherein the training data set comprises a plurality of pieces of sample channel characteristic information and demodulation bit probabilities corresponding to the M modulation bit sequences under the plurality of pieces of sample channel characteristic information.

3. The constellation diagram determination method according to claim 2, wherein the modulation subnetwork comprises:
a bit selection unit configured to select a first bit and a second bit from a modulation bit sequence of the M modulation bit sequences;
a coordinate calculation unit configured to determine absolute values of coordinates of a constellation point corresponding to the modulation bit sequence through the first bit;
a sign calculation unit configured to determine, through the second bit, a quadrant in which the constellation point corresponding to the modulation bit sequence is located; and
a normalization unit configured to normalize the coordinates of the constellation point corresponding to the modulation bit sequences.

4. The constellation diagram determination method according to claim 3, wherein N bit selection units are provided, and N is equal to log₂(M)/2; and
Q coordinate calculation units are provided, and Q is equal to log₂(M)/2−1.

5. The constellation diagram determination method according to claim 3, wherein the modulation subnetwork further comprises:
a coordinate transformation unit configured to transform the coordinates of the constellation point corresponding to the modulation bit sequence from a first coordinate system to a second coordinate system.

6. The constellation diagram determination method according to claim 3, wherein the modulation subnetwork further comprises:
a first identity unit configured to increase a network parameter amount of the modulation subnetwork.

7. The constellation diagram determination method according to claim 2, wherein the demodulation subnetwork comprises:
a log-likelihood ratio (LLR) calculation unit configured to determine an LLR of a received signal; and
a bit probability calculation unit configured to determine a demodulation bit probability through the LLR of the received signal.

8. The constellation diagram determination method according to claim 7, wherein P LLR calculation units are provided, and P is equal to log₂(M)/2.

9. The constellation diagram determination method according to claim 7, wherein the demodulation subnetwork further comprises:
a coordinate inverse transformation unit configured to transform coordinates of the received signal from a second coordinate system to a first coordinate system.

10. The constellation diagram determination method according to claim 7, wherein the demodulation subnetwork further comprises:
a second identity unit configured to increase a network parameter amount of the demodulation subnetwork.

11. The constellation diagram determination method according to claim 3, wherein initializing the network parameter of the modulation subnetwork according to the modulation manner comprises:
determining a first initial parameter of the modulation subnetwork according to a calculation formula of the modulation manner; and
initializing the modulation subnetwork according to the first initial parameter.

12. The constellation diagram determination method according to claim 11, wherein initializing the modulation subnetwork according to the first initial parameter comprises:
scrambling the first initial parameter and initializing the modulation subnetwork according to the scrambled first initial parameter.

13. The constellation diagram determination method according to claim 11, further comprising:
controlling a training attribute of the bit selection unit and a training attribute of the sign calculation unit to be untrainable; or
controlling a training attribute of the bit selection unit and a training attribute of the sign calculation unit to be trainable.

14. The constellation diagram determination method according to claim 2, wherein initializing the network parameter of the demodulation subnetwork according to the demodulation manner comprises:
determining a second initial parameter of the demodulation subnetwork according to a calculation formula of the demodulation manner; and
initializing the demodulation subnetwork according to the second initial parameter.

15. The constellation diagram determination method according to claim 14, wherein initializing the demodulation subnetwork according to the second initial parameter comprises:
scrambling the second initial parameter and initializing the demodulation subnetwork according to the scrambled second initial parameter.

16. (canceled)

17. An electronic device, comprising a memory and a processor, wherein the memory is configured to store a computer program that, when executed by the processor, causes the processor to perform the following:
acquiring channel characteristic information and M modulation bit sequences; and
determining a constellation diagram corresponding to the M modulation bit sequences through a pre-trained neural network,
wherein M denotes a number of points in the constellation diagram, and the constellation diagram corresponds to the channel characteristic information.

18. A non-transitory storage medium storing a computer program that, when executed by a processor, causes the processor to perform the following:
acquiring channel characteristic information and M modulation bit sequences; and
determining a constellation diagram corresponding to the M modulation bit sequences through a pre-trained neural network,
wherein M denotes a number of points in the constellation diagram, and the constellation diagram corresponds to the channel characteristic information.

19. The electronic device according to claim 17, wherein the neural network comprises a modulation subnetwork and a demodulation subnetwork; and
the neural network is determined in the following manner:
constructing the modulation subnetwork according to a modulation manner;
constructing the demodulation subnetwork according to a demodulation manner;
initializing a network parameter of the modulation subnetwork according to the modulation manner;
initializing a network parameter of the demodulation subnetwork according to the demodulation manner; and
training the initialized modulation subnetwork and the initialized demodulation subnetwork according to a training data set to obtain a trained neural network,
wherein the training data set comprises a plurality of pieces of sample channel characteristic information and demodulation bit probabilities corresponding to the M modulation bit sequences under the plurality of pieces of sample channel characteristic information.

20. The electronic device according to claim 19, wherein the modulation subnetwork comprises:
a bit selection unit configured to select a first bit and a second bit from a modulation bit sequence of the M modulation bit sequences;
a coordinate calculation unit configured to determine absolute values of coordinates of a constellation point corresponding to the modulation bit sequence through the first bit;
a sign calculation unit configured to determine, through the second bit, a quadrant in which the constellation point corresponding to the modulation bit sequence is located; and
a normalization unit configured to normalize the coordinates of the constellation point corresponding to the modulation bit sequences.

21. The electronic device according to claim 20, wherein N bit selection units are provided, and N is equal to log₂(M)/2; and
Q coordinate calculation units are provided, and Q is equal to log₂(M)/2−1.
